(19) United States
(12) Patent Application Publication
(10) Pub. No.: US 2016/0224695 A1
(43) Pub. Date: Aug. 4, 2016

(54) SYSTEM, APPLICATION, AND METHOD FOR TELECOMMUNICATIONS FIELD ENGINEERING VIA SMARTPHONE, TABLET, OR OTHER MOBILE INTERFACE

(71) Applicant: Anthony Lee Black, Cartersville, GA (US)

(72) Inventor: Anthony Lee Black, Cartersville, GA (US)

(21) Appl. No.: 14/609,502

(22) Filed: Jan. 30, 2015

(51) Int. Cl. G06F 17/50; H04B 7/26

(52) U.S. Cl. CPC G06F 17/5004; G06F 17/509; H04B 7/26

(57) ABSTRACT

The present invention includes a system and method for telecommunications field engineering and includes a mobile software application which assists the user in processing telecommunications installation tasks. The present invention will allow the user to receive assigned tasks, complete those tasks using tools within the application, and to store and/or transmit the results of those tasks.

### RELATED APPLICATIONS

This application is a non-provisional application of, and claims priority to, U.S. Provisional App. No. 61/935,901 (filed on Feb. 5, 2014).

### FIELD OF THE INVENTION

This invention generally relates to a method and system involving using a mobile device to assist in the field engineering process for telecommunications installations.

### BACKGROUND OF THE INVENTION

As telecommunications systems improve and as residential and commercial construction activities continue, telecommunications providers frequently need to install new or improved cables, including coaxial, copper, or fiber-optic cables. In today's environment, telecommunications providers must be able to aggressively reduce their construction cycles, order-to-connect times, and outside maintenance costs to remain competitive in the marketplace.

Telecommunications field engineers generally are tasked with traveling to a site at which a telecommunications installation is to be performed, whether that be for a new installation or a rebuild or improvement of a current installation. The field engineer would gather information regarding the site that is necessary to assist a design engineer in drafting formal installation plans. The field engineer is also usually tasked with drafting an initial rough draft of the design which may include cable pathways and/or connections necessary for the installation.

However, most of today's telecommunications field engineering involves manual processes that are inefficient, including lots of paper, separate work orders, system maps, and templates for drawing pathway information required for field engineering design and construction. In a typical process, a telecommunications field engineer would: (i) travel to a provider's facility to retrieve forms, information, and instructions on paper for a field engineering task to be performed at an installation site; (ii) travel to the installation site; (iii) obtain information on the site and input this information as well as the initial draft of the installation on the paper documentation; (iv) return back to the provider's facility to provide the design engineer with the paper documentation, with the hope that all information that the design engineer would need to design formal installation plans was contained in the documentation; and (v) usually return back to the installation site to obtain further information that the design engineer might need.

Because these processes relay so heavily on paper, they create unnecessary delay between each of the steps between the field engineers that gather site information and the design engineers. From the time work orders are received until the time they transition to design teams, field engineers need to be able to gather all of the information required to design and construct each job in one survey visit. With today's techniques it can take multiple site visits and several additional days to gather all of the required information and complete a field survey.

Further inefficiency is created due to the need that many organizations have to maintain separate copies of these materials in different departments for future referencing.

In addition, today's field engineering processes lack standardization, which can be especially troublesome when one considers the likelihood of mergers, acquisitions, and other transactions related to telecommunications organizations.

There do exist several computer-related programs that could be used to assist the field engineering process, including electronic communication (such as email or texting), global positioning system (“GPS”) related technology, engineering tools for drawing and data entry, tutorials, and photo and video applications. However, the previous programs do not separately maximize efficiency. Moreover, none of the previous inventions in the field permit users to have an inexpensive, easy-to-use method or interface to allow field technicians to perform all of their work tasks, receive assistance, and record data relevant to these tasks.

As such, there is a need for a new and improved telecommunications field engineering method and system and software application that can be used with any smartphone, digital tablet, or personal computer that is more efficient than previous products and that can be used to fully-integrate and streamline the telecommunications field engineering process.

### SUMMARY OF THE INVENTION

The present invention solves this need and other problems related to telecommunications field engineering.

The present invention relates to a system and method for completing telecommunications field engineering tasks utilizing a mobile smartphone, tablet, or other portable computer or similar device including a display (a “Mobile Device”).

Further embodiments of the present invention also relate to a software program or application (an “App”) connected to a Mobile Device, with the App also providing or permitting digital communication, via wi-fi, Bluetooth, mobile data, or similar transmissions to a centralized network operator, web service, or computer system.

Various other aspects and embodiments of the invention contain a step-by-step process guide, engineering tools for drawing and data entry, communications, GPS-related tools, and a tutorial for completing services orders for field engineering telecommunications networks.

Further features and advantages are apparent from the following detailed description taken in combination with the drawings attached hereto, it being understood that changes may be made in the form, size, proportions, and minor details of construction without departing from the spirit of the invention. This summary is not an intended to be an extensive overview or intended to identify the scope of the invention.

### BRIEF DESCRIPTION OF THE DRAWINGS

Further features and advantages are apparent from the following detailed description, taken in combination with the attached figures, wherein:

FIG. 1 is a diagram illustrating an embodiment of a method of field engineering in accordance with the present invention.

FIG. 2 is a diagram illustrating an expanded view from portions of FIG. 1, further illustrating an embodiment of a method of field engineering in accordance with the present invention.

FIG. 3 is a diagram illustrating an embodiment of a method of field engineering in accordance with the present invention.

FIG. 4 is an illustrated example of a screenshot of a project checklist utilized in various embodiments in accordance with the present invention.

FIG. 5 is an illustrated example of a screenshot of a photograph taken and modified in accordance with the present invention.

FIG. 6 is an illustrated example of a screenshot of a chart or plot of a telecommunications installation in accordance with the present invention.

### DETAILED DESCRIPTION

This Detailed Description merely describes exemplary embodiments in accordance with the general inventive concepts and is not intended to limit the scope of the invention in any way. In fact, the invention described in the specification is broader than and unlimited by the exemplary embodiments set forth herein, and all terms used herein have their full and ordinary meaning. The general inventive concept may be embodied in different forms and should not be construed as limited to the embodiments set forth herein. Rather, these embodiments are provided so that this disclosure will be through and will convey the scope of the general inventive concepts to those skilled in the art. The terminology set forth in this Detailed Description is for describing particular embodiments only and is not intended to be limiting of the general inventive concepts. Moreover, singular forms, such as “a,” “an,” and “the” are intended to include the plural forms as well, unless the context clearly indicates otherwise.

A system, App, and method in accordance with the present invention is shown in the drawings and generally designated.

In a common use of the invention, an field engineering work order for a potential fiber-optic, coaxial, or copper network build, modification, or service request is entered into a database to be delivered digitally to a field engineer. When the field engineering “logs on” the App, the field engineer would receive a request for service and GPS-based directions from his or her current location to the location of a field engineering service order or task to be performed. Once at the location of the service order, the App would assist the field service engineer by guiding him or her through a process to gather and record all pertinent information, including customer entry, building, network data, and digital drawings using a customized process and tools in the App. All of the recording and drawing tools, such as photographic or video recording or transmission, drag-and-drop symbols and icons which may be necessary or useful to perform, record, and document the service order, including identifying pathway routes and associated distances would be included in the App. All data, drawings, and video related to the service order would be geo-coded to the service location as the field engineer performs the work under the service order, and uploaded to an off-site location for future reference or analysis by the field network operator, by other field engineers, or by design engineers who would design formal plans for telecommunications installations.

More generally, the present invention includes a system and App through which, after choosing to accept an assigned task, a field engineer, or user, could: (i) obtain GPS directions to the location of the service order; (ii) obtain contact and other information for the service order customer, (iii) view tutorials or guides for the primary engineering requirements to complete the order; (iv) gather and enter building and construction requirements; (v) create notes to support design and construction requirements; and (vi) access templates and other tools to enter site information, such as pathway dimensions, and to draft engineering routes.

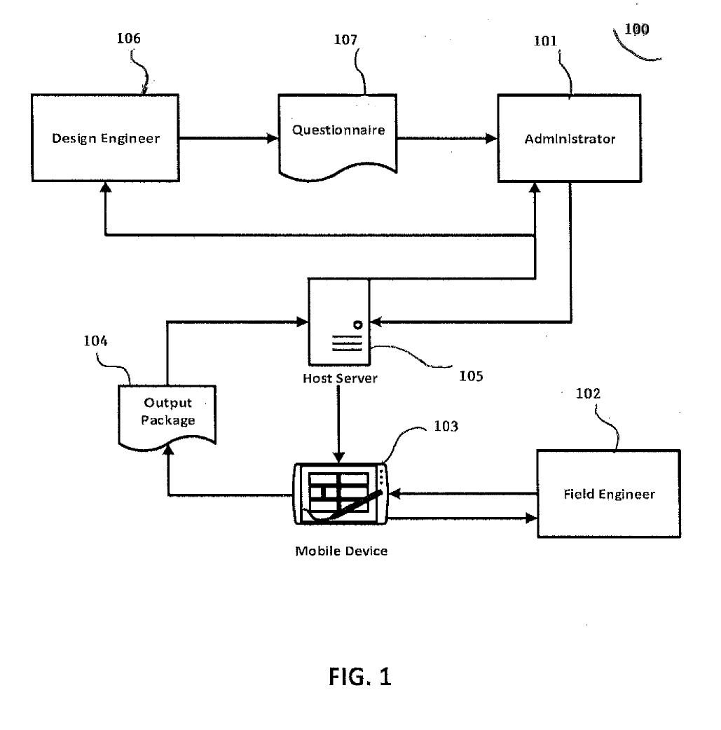

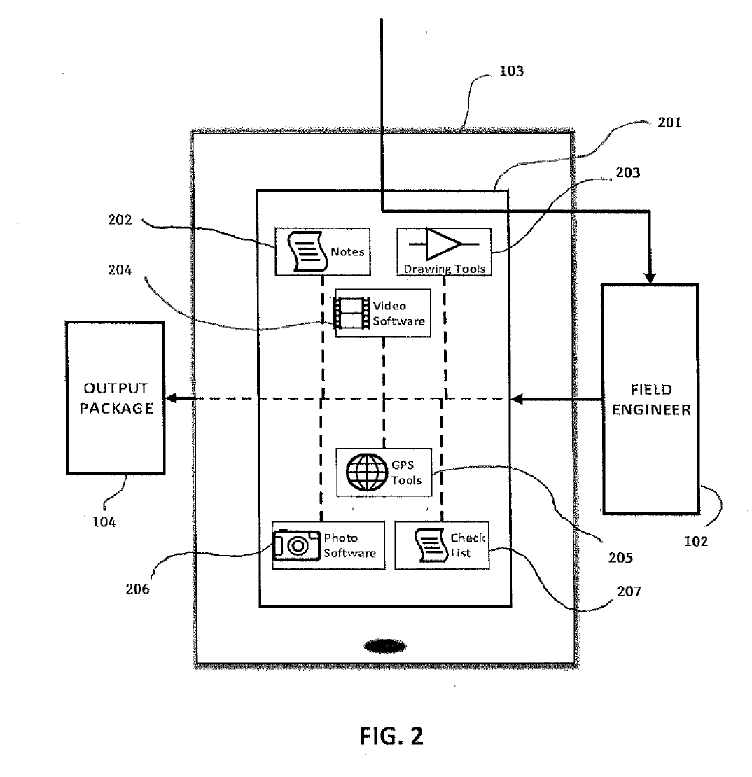

FIG. 1 and FIG. 2 should be considered in conjunction with each other and illustrate an embodiment of a method 100 for completing a telecommunications project in accordance with the present invention.

As shown in FIG. 1, an administrator or manager 101 may assign a field engineering task to a field engineer 102 through an App (201 as shown on FIG. 2) that has been installed on a Mobile Device 103, although in other embodiments the task may be provided to the field engineer through other means of communication, including in person or through an email. This would typically, but not necessarily occur by communicating the task through a network or hosted computer server 105 which would be able to transmit and receive digital data to the Mobile Device 103. A common example of such a task would be to obtain data regarding the site at which the telecommunications project is to be performed, to complete a questionnaire 107 or other list of information that the design engineer 106 provides to the administrator or manager 101 in order to have the field engineer 102 complete while at the site. In addition, it would also be common, as part of a telecommunications task, to have the field engineer 102 make a rough draft of a potential telecommunications installation pathway to the site from an existing telecommunications connection. The Mobile Device 103 on which the App 201 is to be installed should permit or provide for digital communication, via wi-fi, Bluetooth, mobile data, or similar transmissions, to a centralized network, web service, or computer system. The network or host computer server 105 should permit or provide for digital communication to the internet.

FIG. 2 includes an expanded view of the Mobile Device 103 and the App 201 which would be installed on the Mobile Device 103 as part of an embodiment of this method for completing a telecommunications project in accordance with the present invention.

The field engineer 102 would access or “log onto” the App 201 to obtain information regarding the field engineering task to be performed. The field engineer could use the App 201 to access directions to the site on which the task is to be performed via GPS tools or software 205 that has been installed on the Mobile Device. The App 201 also includes tools that would allow the field engineer to complete the design engineer's questionnaire or a checklist 207 and complete the remainder of the field engineering task, such as engineering or CAD drawing or drafting software 203 to plot or chart the telecommunications pathway and photography 206 and video taking software 204 to record images and video at the site that would assist the design engineer to complete the design aspects for the project. The results of the field engineer's work, the field survey output or “Output Package” 104, could then be sent via the App 201 to the administrator/manager 101 or to the design engineer 106 (as shown in more detail on FIG. 1) to confirm that all information needed from the site was included in the field survey output 104 before the field engineer 102 left the site. It is certainly possible, but still within the scope of this embodiment, that the administrator/manager 101 or design engineer 106 is not able to provide this confirmation prior to the field engineer 102 leaving the installation site. Likewise, it is also possible, but still within the scope of this embodiment, that the administrator/manager 101 or design engineer 106 still needs more information from the site and requests that the field engineer 102 use the above-referenced-tools in the App 201 to provide this information and include it in the field survey output 104.

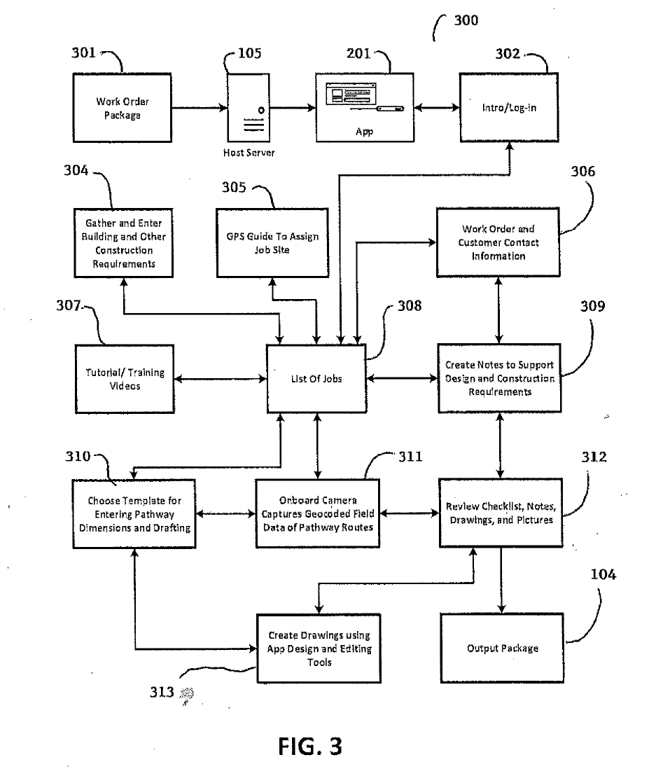

FIG. 3 illustrates an exemplary block diagram of a method for completing a telecommunications project in accordance with the present invention. A work order package 301 with information regarding the field engineering task to be performed is sent to a hosted computer server 105; the work order package 301 could be sent to the hosted computer server through any number of means, including attaching a computer directed to the server and via wi-fi, Bluetooth connection, or any other digital transmission method. The work order package 301 could consist of any number of matters related to the field engineering task to be performed, including the address of the location that the task is to be performed, a list of questions to be answered about the task location, and instructions or a list of assignments. The network or hosted computer server 105 would then transmit—via any of the digital transmission method—the work order package 301 so that it could be accessed one using an App 201 which has been installed on a Mobile Device.

When a user accesses the App 201, the user is first directed to an introductory or landing page 302 which would allow the user to “log in” to use the App 201. From there, the user could then select or be directed to a list 308 of potential field engineering tasks to be performed. After a field engineering task is selected, the App 201 would provide the user with pertinent task information 306 (such as the address of the installation site, a work order number, or customer contact information) related to the task to be performed. The App 201 may also allow the user to access maps of and directions to the installation site via GPS tools or software 305.

Once at the installation site, the user could use the App 201, to perform the user's field engineering tasks, including: (i) access tutorials or training videos 307 that would assist the user in completing the task; (i) creating notes 309 that would be useful in designing the telecommunications installation; (ii) inputting building and construction requirements 304 for the installation; select templates 310 associated with engineering or drafting (such as CAD) tools to enter installation pathway dimensions and to create drawings 313 for a telecommunications installation using the engineering or drafting tools; (iii) use a camera 311 that is connected to or a part of the Mobile Device that the user is using to take videotape or photographs of the installation site; (iv) complete an questionnaire or checklist 312 and review materials to ensure all pertinent information needed to complete the telecommunications installation design has been obtained from the installation site.

After using the App to obtain information, photographs, and/or videos from the site and/or to enter pathway dimensions or create drawings, the user could use the App 201 to share or send the Output Package 104—which could include any notes or other information, any completed questionnaire or checklists, photographs, videos, dimensions, or drawings—to the hosted network computer server 105. As in the embodiment shown in FIG. 1, from the hosted network or computer server 105, another individual or individuals (such as an administrator/manager 101 or design engineer 106) with access to the hosted computer server 105, could review the Output Package 104 for completeness and if, appropriate, communicate with the user, including via the App 201, to either confirm that the Output Package 104 is complete or to provide further instructions so as to enable the user to complete the field engineering task. The Output Package 204 could be sent to the hosted computer server 202 and/or to any other network operator, web service, other Mobile Device, or any computer system, via wi-fi, bluetooth, mobile data, or similar means for future reference or analysis or could be stored on any data storage medium.

The tutorials or training videos 307 may be accessed within the App 201 itself or by providing a means through the App 201 to access training videos that may be stored elsewhere, such as with links to video hosting sites that may be viewed through the internet or via similar transmission methods.

As it relates to creating notes 309, this would be possible through any number of methods, including using word-processing software or software that create a “white board” screen on which a user could use his or her finger or a stylus, to handwrite notes on the Mobile Device's touch screen display. The user could then use the App 201 to save and/or store these notes as part of the Output Package 104 or to a data storage medium, including any data storage medium that is affixed to or a part of the Mobile Device.

The camera 311 accessible through the App 201, would enable the user to take and photographs or videos related to the installation site. The App 201 would also give the user the option to utilize GPS software accessible through the Mobile Device to embed or geo-code the location of the photographs or videos so that one could determine the exact location of the place where the photographs or videos were taken. Information regarding the location of the photographs or videos could then be saved to a data storage medium and/or stored as part of the Output Package 104. Such information would be especially useful to one accessing Output Package 104 as part of an installation design. Similarly, the App 201 would permit the user to utilize GPS software accessible through the Mobile Device to embed or geo-code the location of any aspect of the drawings 313 so that this information may be saved and stored as part of the Output Package 104.

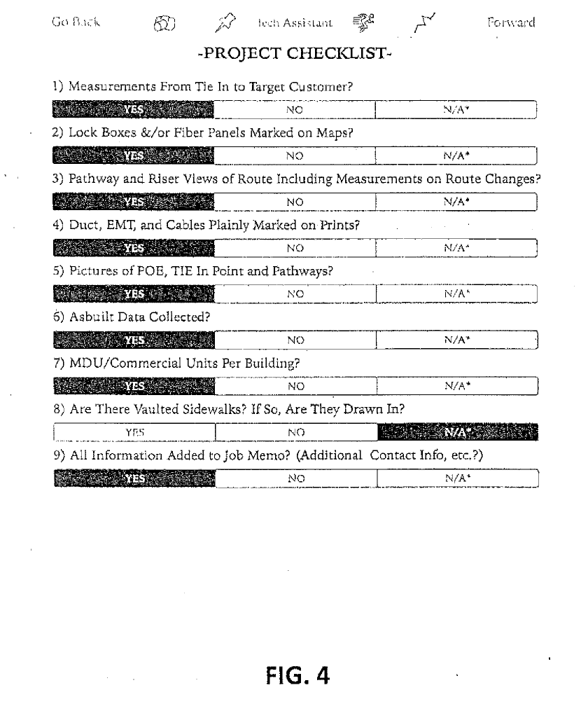

FIG. 4 is an illustrated example of a screenshot of a “project checklist” 400 utilized in various embodiments in accordance with the present invention. The project checklist 400 includes questions that the field engineer may be asked to answer while at a telecommunications installation site; the primary, but not sole, purpose of such project checklist 400 would be ensure that the field engineer has obtained all information necessary to complete the field engineering task and that all such information is included in an Output Package. In this example, the field engineer is asked to answer nine questions regarding the installation site and regarding the Output Package being created by the field engineer. These questions as well as the actual form of the questions are provided for example only, and the project checklist 400 could be any in any format that would be able to be transmitted digitally and could include any number of possible questions or inquiries for the field engineer to answer.

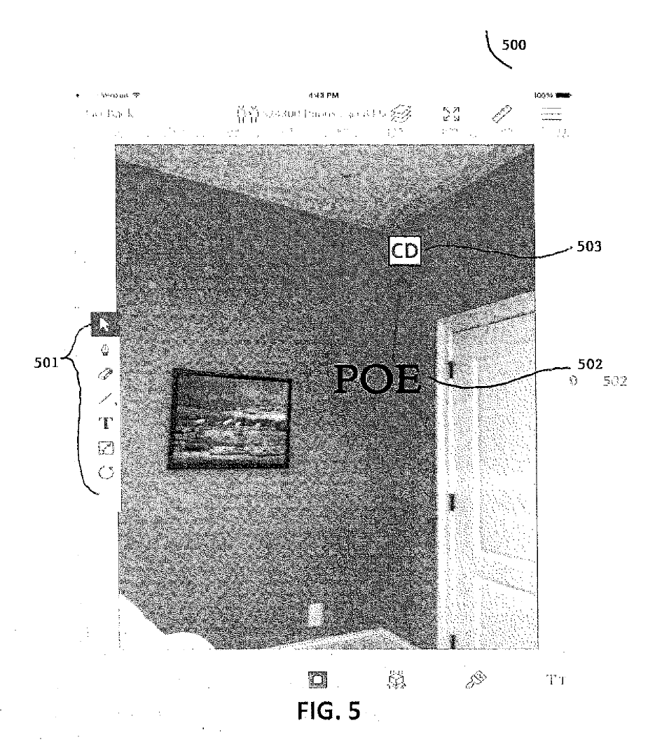

FIG. 5 is an illustrated example of a screenshot of a photograph taken with an App and modified through the App in accordance with the present invention. A photographic image 500 would be created when the user took a picture using photographic software accessible through an App that had been installed on a Mobile Device; this image would be saved on a data storage medium that is affixed to or a part of a Mobile Device. The App would allow the user the user to embed notations or symbols onto the photographic image 500 so that one viewing the photographic image 500 at a later time could see both the photographic image 500 and any notations or symbols. An array of notational tools and symbols 501 would be included within the App that the user could click on, tap, or drag-and-drop so as to permit notations or symbols to be embedded onto the photographic image 500. In this photographic example, the user has embedded the letters “POE” 502, indicating point-of-entry for a telecommunications installation. The letters “POE” 502 point to a symbol “CD,” 503 which is an abbreviation for core drill and has also been embedded onto the photographic image 500. These particular embedded notations and symbols would enable one viewing the photographic image 500 at a later date to view the location suggested to make a core drill. The particular notations and symbols are provided by example only, and any number of notations, words, letters, or symbols could be embedded onto a photographic image in accordance with the present invention.

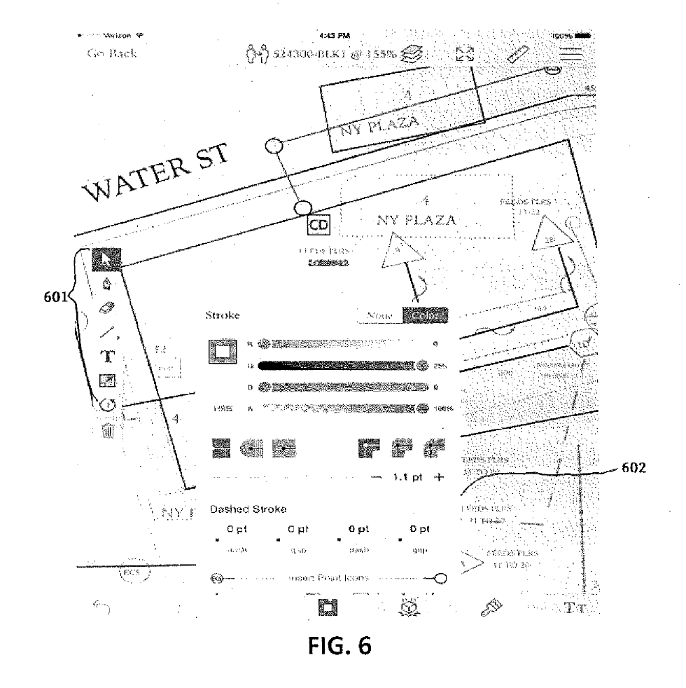

FIG. 6 is an illustrated example of a draft of a telecommunications installation in accordance with the present invention. Specifically 600 reflects an example of a draft of a telecommunications installation that would be prepared using an App that had been installed on a Mobile Device. An array of notational tools and symbols 601 would be included within the App that the user could click on, tap, or drag-and-drop so as to permit notations or symbols to be embedded onto the draft. The App also includes drafting tools 602 to enable the user to create a draft of suggested or actual telecommunications pathways and physical features.

One of ordinary skill in the art will appreciate the broad applicability of having an App with that provides functionality to complete telecommunications field engineering tasks on a Mobile Device, especially when one considers that all of the tools necessary to complete these tasks may be accessible through one App. This functionality is in contrast to the current methods requiring paper or non-digital transmission.

Other embodiments and uses of the invention would permit the field engineer to utilize a various aspects of the above referenced methods, systems, or App to complete the telecommunications field engineering tasks utilizing the tools, means, and methods described herein.

While various inventive aspects and features of the general inventive concepts are described and illustrated herein in the context of various exemplary embodiments, these various aspects and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components) may be described herein, such descriptions are not intended to be a complete or exhaustive list of available alternative embodiments, Whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Descriptions of exemplary methods or processes are not limited to inclusion of all steps as being required in all cases, nor is the order that the steps are presented to be construed as required or necessary unless expressly so stated.

What is claimed is:

1. A telecommunications field engineering system comprising:
a first computer device, including a means for sending and receiving data from other computer devices;
a second computer device including a means for sending and receiving data with the first computer device; and
a drafting component which contains drafting tools which permit a user of the second computer device to plot and/or chart telecommunications installations and to send a plot or design to the first computer device.

2. A telecommunications field engineering system according to claim 1, wherein both means for sending and receiving data is via wi-fi, Bluetooth, mobile data or similar wireless communication system.

3. A telecommunications field engineering system according to claim 1, further comprising a centralized network or computer system.

4. A telecommunications field engineering system according to claim 1, further comprising a means to store the plot(s) or design(s) in a data storage medium.

5. A telecommunications field engineering system according to claim 1, further comprising a note taking component which permits the user of the second computer device to take notes regarding the installation and to store those notes to a data storage medium and/or to send those notes to the first computer device.

6. A telecommunications field engineering system according to claim 1, further comprising an imaging component which permits a user of the second computer device to take photographs and record videos of telecommunications components and locations.

7. A telecommunications field engineering system according to claim 1, further comprising a training component which would permit a user of the second computer device to review pre-recorded training videos.

8. A telecommunications field engineering system according to claim 1, further comprising a location component which would permit a user of the second computer device to utilize a global positioning system.

9. A telecommunications field engineering system according to claim 8 wherein the location component would utilize a global positioning system to embed or geo-code the location of the plot(s) or design(s) as they are being saved and/or sent.

10. A computer software application for telecommunications field engineering comprising:
a means of receiving information on a telecommunications task to be completed;
a drafting component which contains drafting tools which permit a user to plot and/or chart telecommunications installations;
a means of saving the plot and/or design to a data storage medium; and
a means of sending the plot and/or design to another computer device;

11. A computer software application according to claim 10, wherein the means for receiving information on a telecommunications task to be completed is via wi-fi, Bluetooth, mobile data or similar wireless communication system.

12. A computer software application according to claim 10, wherein the means for sending the plot(s) or design to another computer device is via wi-fi, Bluetooth, mobile data or similar wireless communication system.

13. A computer software application according to claim 10 further comprising an imaging component which permits a user to take photographs and record videos of telecommunications components and locations.

14. A computer software application according to claim 10 further comprising a training component which would permit a user review pre-recorded training videos.

15. A computer software application according to claim 10 further comprising a note taking component which permits a user to take notes regarding the installation and to store those notes to a data storage medium and/or to send those notes to another computer device

16. A computer software application according to claim 10 further comprising a location component which would permit a user to utilize a global positioning system.

17. A computer software application according to claim 16 wherein the location component would utilize a global positioning system to embed or geo-code the location of the plot or design as they are being saved and/or sent.

18. A method of processing telecommunications field engineering data in a mobile computer device, the method comprising:
receiving information on a telecommunications task to be completed;
recording details concerning the location in which the telecommunications task is to be completed;
preparing installation charts for proposed telecommunications installations; and
sending data of the recorded locations details and the installation charts from the mobile computer device to a data storage medium or to another computer or computer system.

19. A method according to claim 18, wherein data and charts are sent from the mobile computer system via wi-fi, Bluetooth, mobile data or similar wireless communication system.

20. A method according to claim 18, wherein information on a telecommunications task is received by the mobile computer device via wi-fi, Bluetooth, mobile data or similar wireless communication system.
